(19) United States
(12) Patent Application Publication
(10) Pub. No.: US 2013/0046482 A1
(43) Pub. Date: Feb. 21, 2013

(54) SYSTEM AND METHOD FOR ASSOCIATING A MODULI SPACE WITH A MOLECULE

(71) Applicants: Jørgen Ellegaard Andersen, Arthus N (DK); Robert Penner, Los Angeles, CA (US)

(72) Inventors: Jørgen Ellegaard Andersen, Arthus N (DK); Robert Penner, Los Angeles, CA (US)

(21) Appl. No.: 13/502,557

(22) PCT Filed: Oct. 19, 2010
(86) PCT No.: PCT/DK2010/050274

§ 371 Date: Nov. 7, 2012

(30) Foreign Application Priority Data
Oct. 19, 2009 (DK) PA2009 70162

(51) Int. Cl. G06F 19/00; G06G 7/60; G06G 7/58

(52) U.S. Cl. 702/21; 703/12; 703/11

(57) ABSTRACT

The present invention relates to a system and a method for constructing and associating a moduli space to a molecule or a model of a molecule. This mathematical representation of molecular structures enables the prediction of actual physical molecular structures. Molecular structures can be structures of macromolecules such as protein molecules and protein globules.

The present invention relates to a system and a method for constructing and associating a moduli space to a molecule or a model of a molecule. This mathematical representation of molecular structures enables the prediction of actual physical molecular structures. Molecular structures can be structures of macromolecules such as protein molecules and protein globules.

### BACKGROUND

Three-dimensional macromolecular structures can be described by the specification of the spatial coordinates of the constituent atoms. A key example is given by the Protein Data Bank (PDB), which enumerates the known three-dimensional protein structures which have been experimentally determined by nuclear magnetic resonance or X-ray crystallography techniques. Specific entries in the PDB consist of the so-called primary structure of a protein molecule given by the sequence of amino and/or imino acid residues along the backbone, together with the spatial coordinates of the atoms comprising the backbone and the residues. Each entry of the PDB thus contains massive data, and it is a significant problem how to classify or compare entries in the PDB for example by computing and comparing summary statistics. The summary statistics of known utility include the determination of so-called alpha helices (α-helices) and beta strands (β-strands) and their organization into a number of standard architectural motifs such as beta propellers, alpha beta alpha sandwiches, and so on. This determination of architectural type is provided manually without any precise definitions. Another key example is the CATH databank derived from the PDB, which organizes protein domains or globules according to Class (alpha, beta, mixed alpha beta and sparse alpha beta), Architecture (consisting of 40 standard motifs), Topology (a refinement of architecture that includes position along the backbone) and Homology (a refinement of topology that includes similarity of primary structure).

A previous application WO 2010/000268 (PCT/DK2009/050155) entitled “System and method for modelling a molecule with a graph” submitted by the inventors evolved around the concept of a fatgraph. This application is hereby incorporated by reference in its entirety. A fatgraph is a combinatorial object which was first defined by R. C. Penner in Perturbative series and the moduli space of Riemann surfaces, Journal of Differential Geometry 27 (1988), 35-53. A fatgraph determines a corresponding surface with boundary. Fatgraphs have been employed in a number of computations in geometry and in the string theory of high-energy physics. A fatgraph is a graph in the usual sense of the term together with the further specification of a cyclic ordering on the half-edges about each vertex.

### SUMMARY OF THE INVENTION

The previous fatgraph model disclosed in WO 2010/000268 arose from discretization of SO(3) connections (twisted-untwisted fatgraph). An object of the present invention is to predict actual physical molecular structures.

This is achieved by a method for constructing and associating a moduli space to a molecule or a model of a molecule, said method comprising the steps of:
associating a graph to said molecule, said graph comprising vertices and edges, wherein vertices are associated with atoms (points) and edges are associated with chemical bonds between atoms,
associating a 3-frame to each of at least two bonds in the molecule,
providing at least one graph connection of said graph by associating an element of a Lie group to at least one pair of 3-frames, and
providing a moduli space of the molecule as the moduli space of general graph connections of said graph for said Lie group.

The invention further relates to a system for constructing and/or associating a moduli space to a molecule or a model of a molecule, said method comprising:
means for associating a graph to said molecule, said graph comprising vertices and edges, wherein vertices are associated with atoms (points) and edges are associated with chemical bonds between atoms,
means for associating a 3-frame to each of at least two bonds in the molecule,
means for providing at least one graph connection of said graph by associating an element of a Lie group to at least one pair of 3-frames, and
means for providing a moduli space of the molecule as the moduli space of general graph connections of said graph for said Lie group.

By the system and method according to the invention, automatic classification, comparison, specification, analysis and/or prediction of molecular structures can be provided because these molecular structures are represented by explicit combinatorial objects, and descriptors of the molecular structure can be derived from the graph constructed in this manner. The combinatorial objects representing these molecular structures can subsequently be stored, processed, and manipulated digitally. A key novelty of the present invention is that these descriptors thereby can be automatically computed from molecular databases, such as PDB or CATH, with no qualitative human intervention or subjective criteria.

In a further embodiment of the invention each 3-frame is a positively oriented orthonormal 3-frame. Further, a 3-frame may be associated to each chemical bond in the molecule. An element of the Lie group may be associated to each adjacent pair of 3-frames.

In one embodiment of the invention the Lie group is a rotation group. Preferably the rotation group is the special orthogonal group SO(3). Thereby the associated moduli space is an SO(3) moduli space of general graph connections of said graph. Thus, in one aspect of the invention the present invention provides use of moduli space techniques to predict SO(3) graph connections. In another aspect of the invention the Lie group is the special unitary group SU(n), such as SU(2).

In one embodiment of the invention a 3-frame F=(\vec{u}, \vec{v}, \vec{w}) associated to a chemical bond comprises the unit vectors \vec{u}, \vec{v} and \vec{w} where \vec{u} is the unit vector in the direction of the chemical bond, \vec{v} is the unit vector provided from projecting a vector from the initial point of the chemical bond towards the heaviest sub-molecule onto the perpendicular direction of vector \vec{u}, and \vec{w} is the cross product of \vec{u} and \vec{w} in this order.

This may be expressed as: A 3-frame F=(\vec{u}ᵢ, \vec{v}ᵢ,\vec{w}ᵢ) associated to a chemical bond comprises the unit vectors \vec{u}ᵢ, \vec{v}ᵢ, and \vec{w}ᵢ defined as:

$${\vec{u}}_{i} = \frac{1}{\vert {\vec{x}}_{i} \vert} {\vec{x}}_{i} , \\ {\vec{v}}_{i} = \frac{1}{\vert {\vec{y}}_{i} - ( {\vec{u}}_{i} \cdot {\vec{y}}_{i} ) {\vec{u}}_{i} \vert} ( {\vec{y}}_{i} - ( {\vec{u}}_{i} \cdot {\vec{y}}_{i} ) {\vec{u}}_{i} ) , \\ {\vec{w}}_{i} = {\vec{u}}_{i} \times {\vec{v}}_{i}$$

where \vec{x}ᵢ is the vector from a first atom of the chemical bond to a second atom of the chemical bond and \vec{y}ᵢ is the vector from said first atom to the heaviest sub-molecule.
Definitions (at Least Partly from Wikipedia)

### Moduli Space

In algebraic geometry, a moduli space is a geometric space whose points represent algebro-geometric objects of some fixed kind, or isomorphism classes of such objects. Such spaces frequently arise as solutions to classification problems: If one can show that a collection of interesting objects (e.g., the smooth algebraic curves of a fixed genus) can be given the structure of a geometric space, then one can parametrize such objects by introducing coordinates on the resulting space. In this context, the term “modulus” is used synonymously with “parameter”; moduli spaces were first understood as spaces of parameters rather than as spaces of objects.

### Graph

A graph in the usual sense of the term is an abstract representation of a set of objects where some pairs of the objects are connected by links. The interconnected objects are represented by mathematical abstractions called vertices, and the links that connect some pairs of vertices are called edges. Typically, a graph is illustrated in diagrammatic form as a set of dots for the vertices, joined by lines or curves for the edges. Vertices may also be termed nodes or points, and edges may also be termed lines. Cutting an edge of a graph in half produces two segments which are termed half-edges. Graphs with labels attached to edges and/or vertices are generally designated as labelled. Correspondingly, graphs in which vertices are indistinguishable and edges are indistinguishable are called unlabelled.

An oriented edge (also termed directed edge) is an ordered pair of vertices that can be represented graphically as an arrow drawn between the vertices. An undirected edge disregards any sense of direction.

Properties of graphs may also be termed invariants. When a graph has been associated with a molecule, such as a protein, the properties of the graph can be used to provide a number of protein descriptors, which for example can be used to predict protein functional families. Thus, properties and invariants of graphs in a mathematical terminology give rise to descriptors in a biochemical terminology. There might even be a mix of terminologies when protein descriptors are themselves termed invariants.

### Rotation Group

In mechanics and geometry, the rotation group is the group of all rotations about the origin of three-dimensional Euclidean space R³ under the operation of composition. By definition, a rotation about the origin is a linear transformation that preserves length of vectors (it is an isometry) and preserves orientation (i.e. handedness) of space. Composing two rotations result in another rotation. Every rotation has a unique inverse rotation. The identity map satisfies the definition of a rotation. Owing to the above three properties, the set of all rotations is a group under composition. The rotation group is a Lie Group.

Every rotation maps an orthonormal basis of R³ to another orthonormal basis. Like any linear transformation, a rotation can always be represented by a matrix. Let R be a given rotation. With respect to the standard basis (e1,e2,e3) of R³ the columns of R are given by (Re1,Re2,Re3). Since the standard basis is orthonormal, the columns of R form another orthonormal basis. This orthonormality condition can be expressed in the form R^{T}R=I, where R^{T} denotes the transpose of R and I is the 3×3 identity matrix. Matrices for which this property holds are called orthogonal matrices. The group of all 3×3 orthogonal matrices is denoted O(3), and consists of all proper and improper rotations.

### SO(3)—The Special Orthogonal Group

In addition to preserving length, proper rotations must also preserve orientation. A matrix will preserve or reverse orientation according to whether the determinant of the matrix is positive or negative. For an orthogonal matrix R, note that det R^{T}=det R implies (det R)²=1 so that det R=±1. The subgroup of orthogonal matrices with determinant +1 is called the special orthogonal group, denoted SO(3).

Thus every rotation can be represented uniquely by an orthogonal matrix with unit determinant. Moreover, since composition of rotations corresponds to matrix multiplication, the rotation group is isomorphic to the special orthogonal group SO(3).

Improper rotations correspond to orthogonal matrices with determinant −1, and they do not form a group because the product of two improper rotations is a proper rotation.

In other words: The Lie group SO(3) is the group of three-by-three matrices A whose entries are real numbers satisfying AA^{t}=I, where A^{t} denotes the transpose of A, i.e., the rows of A^{t} are the columns of A, and I denotes the identity matrix. A distance function or metric on SO(3) is a function d: SO(3)×SO(3)→R satisfying the usual properties of distance, and is said to be bi-invariant provided d(CAD,CBD)=d(A,B) for any A,B,C,DεSO(3). The Lie group SO(3) supports a unique bi-invariant metric

d(A,B)=½trace(log(AB^{t})²

where the trace of a matrix is the sum of its diagonal entries and the logarithm is the matrix logarithm.

For any A₁, A₂εSO(3), d(A₁,l)<d(A₂,l) if and only if trace(A₂)<trace(A₁), where d is the unique bi-invariant metric on SO(3).

### Graph Connections

Suppose that [symbol] is a graph. An SO(3) graph connection on [symbol] is the assignment of an element A_{f}εSO(3) to each oriented edge f of [symbol] so that the matrix associated to the reverse of f is the transpose of A_{f}.

Two such assignments A_{f} and B_{f} are regarded as equivalent if there is an assignment CᵤεSO(3) to each vertex u of [symbol] so that A_{f}=CᵤB_{f}C_{w}⁻¹, for each oriented edge f of [symbol] with initial point u and terminal point w.

An SO(3) graph connection on [symbol] determines an isomorphism class of flat principal SO(3) bundles over [symbol] .

Given an oriented edge-path γ in [symbol] described by consecutive oriented edges f₀-f₁- . . . -fₖ₊₁, where the terminal point of t is the initial point of fᵢ₊₁, for i=0, . . . , k. The parallel transport operator of the SO(3) graph connection along γ is then given by the matrix product ρ(γ)=A_{f}_{_{—}}₀A_{f}_{_{—}}₁ . . . A_{f}_{_{—}}ₖεSO(3).

In particular, if the terminal point of fₖ agrees with the initial point of f₀ so that γ is a closed oriented edgepath, then trace(ρ(γ)) is the holonomy of the graph connection along γ and is well-defined on the equivalence class of graph connections.

For any closed oriented edge-path f₀-f₁- . . . -fₖ, in the graph, where AₖεSO(3) is the value of the graph connection on the oriented edge fₖ, the product A_{f}_{_{—}}₀A_{f}_{_{—}}₁ . . . A_{f}_{_{—}}ₖ of matrices in SO(3) is the identity matrix. The graph connection A_{f}_{_{—}}₀A_{f}_{_{—}}₁ . . . A_{f}_{_{—}}ₖ is then said to have trivial holonomy, also termed no holonomy.

In the previous application WO 2010/000268 a backbone graph connection was created that completely described the evolution of 3-frames of peptide units along a protein backbone. In order to determine the fatgraph model of the backbone one or the other of the two configurations of fatgraph building block for each peptide unit had to be chosen. The fatgraph model of the protein backbone thereby developed from the natural discretization of the natural SO(3) graph connection K on [symbol] . However, this limiting discretization is circumvented in the present invention.

### DRAWINGS

FIG. 1 illustrates modelling of a peptide unit with a subgraph building block.

FIG. 2 illustrates modelling of a peptide unit preceding a cis-Proline with a subgraph building block.

FIG. 3 illustrates the connection of subgraph building blocks along the backbone of a protein

FIG. 4 illustrates the two standard conformational angles φᵢ and ψᵢ.

FIG. 5 illustrates the adding of edges to the subgraph building blocks to represent the hydrogen bonds along the backbone of a protein.

FIG. 6 shows orientable surfaces on the left and non-orientable surfaces on the right.

FIG. 7 illustrates the conformational angles φᵢ, ψᵢ and χᵢ.

FIG. 8 illustrates the present graph connection approach.

FIG. 9 is a flow chart for one embodiment of the invention.

FIG. 10 show scatter plots for hydrogen bonding over the entire CATH database involving the amino acids.

### DETAILED DESCRIPTION OF THE INVENTION

By the system and method according to the invention, automatic classification, comparison, specification, analysis and/or prediction of molecular structures can be provided because these molecular structures are represented by explicit combinatorial objects, and descriptors of the molecular structure can be derived from the graph constructed in this manner. The combinatorial objects representing these molecular structures can subsequently be stored, processed, and manipulated digitally. A key novelty of the present invention is that these descriptors are automatically computable from molecular databases, such as PDB or CATH, with no qualitative human intervention or subjective criteria.

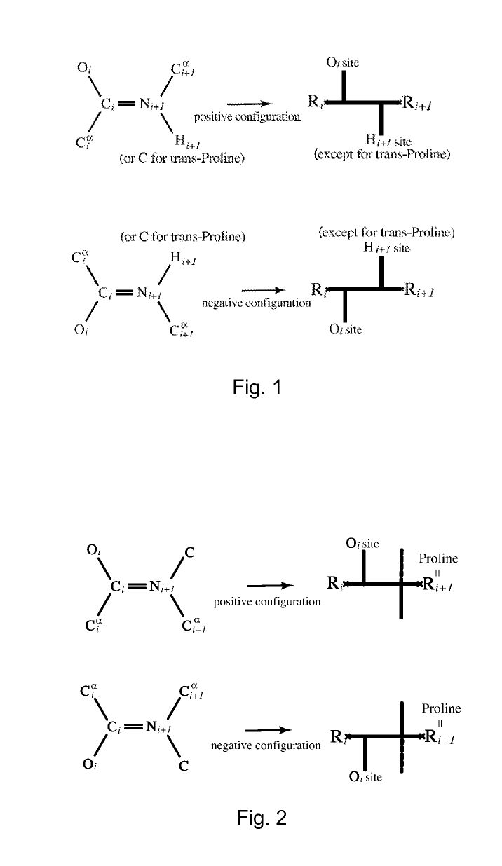

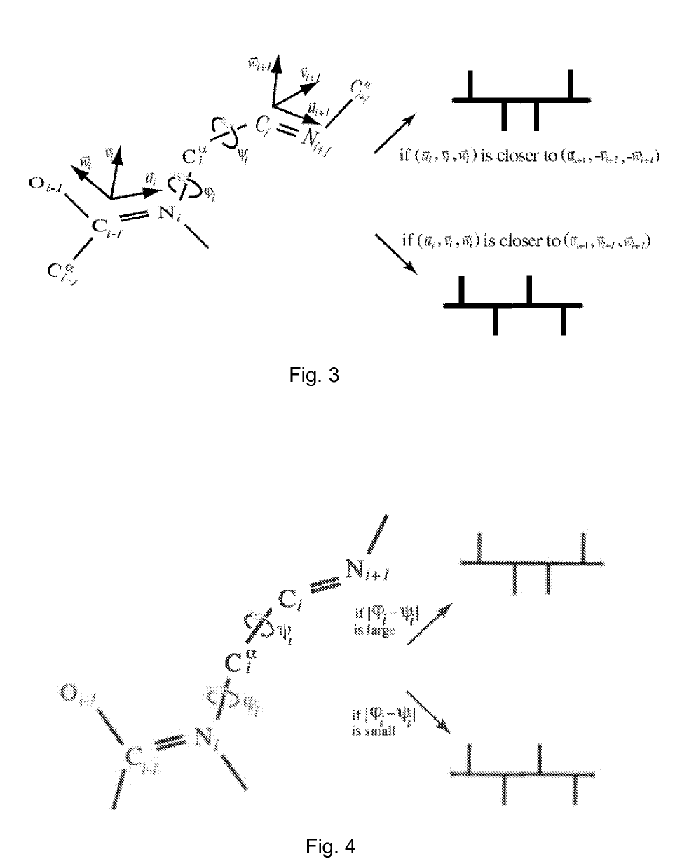

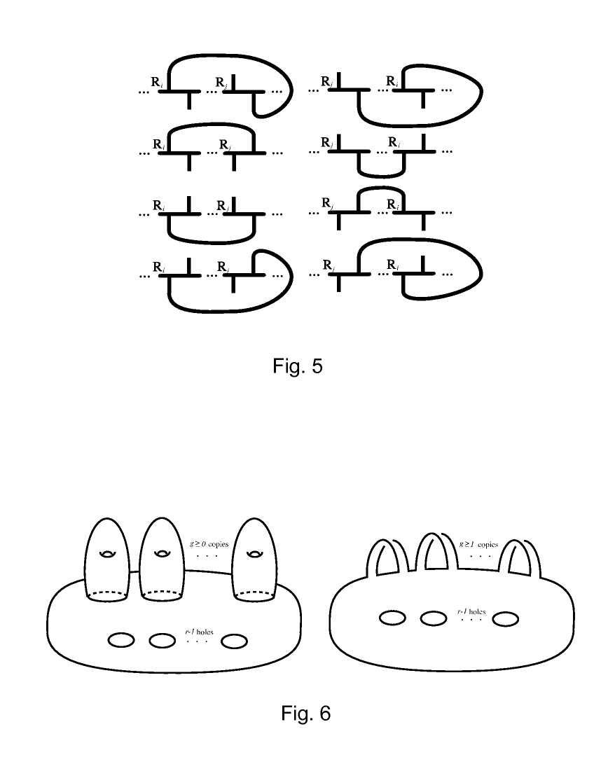

A graph can be associated to any three-dimensional molecule. The system and method according to the invention may thereby be applied to any molecule. According to the fatgraph application WO 2010/000268 a fatgraph could be associated with any protein molecule or protein globule structure together with a labelling of certain edges of the fatgraph by its residues. To each peptide unit of a protein or protein globule was associated a standard building block for a fatgraph as illustrated in FIG. 1, where the indicated “sites” correspond to sequential oxygen and hydrogen atoms of the peptide unit for amino acids and have the slightly different interpretation for imino acids illustrated in FIG. 2. The label indicates which residue occurs along the backbone. These building blocks were assembled into a model for the backbone, where the relative spatial coordinates of constituent atoms and the nearby residue types were used to determine the sequential arrangement of these building blocks as illustrated in FIGS. 3 and 4. The fatgraph associated to the protein molecule or protein globule was completed by adding an edge connecting pairs of sites for each hydrogen bond along the backbone. This is illustrated in FIG. 5.

From a constructed fatgraph, there are a number of numerical and other properties that can be defined including but not limited to: the genus of the corresponding surface and its number of boundary components; the sequence of lengths, as edge-paths or as number of peptide units traversed, of its boundary components; the average length of its boundary components; the lengths or average lengths of boundary components passing through each residue type. The most refined property is the isomorphism class itself of the labelled fatgraph constructed, and this too can conveniently be described as a data type on the computer. Weaker properties also arise by considering notions of approximate identity among fatgraphs.

The generalization as taught by the present invention, provided by the association of 3-frames along the backbone, opens a new world of possibilities. In effect, just as the conformational angles φ and ψ have certainly proved a useful vocabulary and formalism for backbone conformations, the present invention introduces rotation matrices in SO(3) or other Lie groups as a vocabulary and formalism for other protein interactions. Thus, an element of SO(3) can now be assigned to a hydrogen bond or to two peptide units that are regarded as being in contact, for example in proximate spatial contact, electrostatic, or other potential interaction strength. Now armed with these new and efficient geometric tools to describe protein interactions, the present invention provides a tool to proceed to empirical considerations and study the existing databases in order to determine distributions on SO(3) corresponding, for example, to particular tuples of primary structure. Nobody has before probed the statistics of the geometry of these secondary and tertiary protein interactions absent the basic vocabulary that is presented here. At any rate, these statistics can evidently now be profitably employed to predict new protein molecular structure from empirically determined geometric constraints.

### Graph Building

An initial part of the invention relates to associating a graph to a molecule (or a model of said molecule), i.e. the equivalent of modelling the molecule by a graph. Most molecules can be divided into smaller parts, i.e. sub-molecules. A molecule can thereby be represented by a plurality of sub-molecules, such as a concatenation of sub-molecules in a linear polymer. Thus, the molecule may be represented by a concatenation of at least two sub-molecules. For example a protein may be represented as the concatenation of the peptide units constituting the backbone of the protein. Correspondingly the graph may comprise a sequence of subgraph building blocks, each subgraph building block preferably representing a sub-molecule.

Input to the model can be the three-dimensional structure of a molecule given by spatial coordinates of the constituent atoms and those pairs of oxygen and hydrogen atoms along the backbone which are bonded as well as its primary structure of residues occurring along the backbone.

As known from the fatgraph application WO 2010/000268 each subgraph building block may comprise a horizontal line segment and a vertical line segment attached on each side of the horizontal line segment, each horizontal and vertical line segment corresponding to an edge of the graph and representing a chemical bond between constituent atoms of the molecule. To proceed with the graph modelling the spatial coordinates and the relative spatial location of the constituent atoms of the molecule are preferably provided, e.g. obtained from a databank.

The spatial coordinates and the relative spatial location of the constituent atoms of the molecule may further provide that:
the position of the first subgraph building block can be correlated with the spatial coordinates of constituent atoms of the first sub-molecule,
the subgraph building blocks are connected in series based upon the relative spatial coordinates of constituent atoms comprising the sub-molecules, and
edges are provided to the graph by connecting segments of the subgraph building blocks, each such edge corresponding to a chemical bond of the molecule.

In a special case each subgraph building block comprises a horizontal line segment, said horizontal line segment preferably representing a carbon-nitrogen bond, and a vertical line segment attached on each side of the horizontal line segment, the first and leftmost vertical line segment representing an oxygen site. The spatial coordinates and the relative spatial location of the constituent atoms of the molecule may thereby provide that:
the position of the first and leftmost vertical line segment of each subgraph building block can be correlated with the orientation of the oxygen atom on the backbone of the sub-molecule,
the horizontal segments of the subgraph building blocks are connected in series based upon the relative spatial coordinates of constituent atoms comprising the sub-molecules, and
edges are provided to the graph by connecting vertical segments, each edge corresponding to a hydrogen bond along the backbone of the molecule.

### Examples of Types of Molecules

In the preferred embodiment of the invention the molecule is a macromolecule such as a biomolecule. A macromolecule is a molecule comprising tens or even hundreds or thousands of atoms, possibly even billions of atoms. The graph is then determined by the primary structure of the macromolecule. Consequently the graph may be constructed at least partly based on data from the protein data bank (PDB). Other examples of molecules are a binary macromolecule, a non-binary macromolecule, a protein or a protein globule, an enzyme, a ligand, a linear polymer, a nucleotide or a nucleic acid, RNA, mRNA, rRNA or tRNA, DNA or fragments thereof.

### Holonomy

A key concept of the present invention is the consideration of the moduli space of general graph connections on an appropriate graph for some Lie group G such as G=SO(3). In math both the group G and the graph (or at least its Euler characteristic or some other topological invariant) is often fixed. However, in this case the graph is allowed to vary in order to model the possible contacts of e.g. an evolving protein.

Thus, according to the invention a moduli space is associated to a molecule as the moduli space of general graph connections of the graph that has been associated with the molecule. In one embodiment of the invention the parallel transport operator of at least one oriented edge-path in r of the graph is calculated. If the rotation group is SO(3) then an oriented edge-path in the graph can be described by consecutive oriented edges e₀-e₁- . . . -eₖ₊₁, where the terminal point of eᵢ is the initial point of eᵢ₊₁, for i=0, . . . , k and the parallel transport operator of the SO(3) graph connection along γ is given by the matrix product ρ(γ)=Aₑ_{_{—}}₀Aₑ_{_{—}}₁ . . . Aₑ_{_{—}}ₖεSO(3).

Another reason that a graph connection may be non-molecular is that there may be non-trivial holonomy. Non-trivial holonomy just means that the holonomy of the graph connection is not trivial. SO(3) graph connections that arise from a molecule in 3-space necessarily have trivial holonomy since a cycle in the graph just corresponds to a cycle of orthonormal 3-frames.

Thus, in a further embodiment of the invention searching for trivial and/or non-trivial holonomy for a plurality of graph connections in the moduli space of the graph is provided. Preferably the holonomy of a graph connection along an oriented edge-path γ is defined as trace(ρ(γ)) where trace(ρ(γ)) is the parallel transport operator of the SO(3) graph connection along γ.

General SO(3) graph connections can describe a geometry that is non-molecular (i.e. non-physical) since a graph connection may determine a configuration that violates steric conditions that the “ball and tube” model of the molecule is embedded in 3-space. Thus, preferably configurations of graph connections from the moduli space that violate steric constraints are excluded. Graph connections that provide non-trivial holonomy may also be excluded.

It is the extension from the special graph connections with no holonomy that satisfy appropriate steric constraints that actually arise for molecules embedded in 3-space to the general graph connections that is the one of the main contents of the present invention.

Several different data sets may be used to determine several different sub-graph connections which combine in the natural way to give a graph connection which has non-trivial holonomy. Methods of steepest descent to reduce holonomy, which are standard techniques to the skilled person in the field of moduli spaces, can then be used to sensibly combine these data and produce a holonomy-free graph connection.

### Molecular Modelling

According to Wikipedia the following protein modelling and prediction technologies are known in the art:

Protein threading, also known as fold recognition, is a method of computational protein structure prediction used for protein sequences which have the same fold as proteins of known structures but do not have homologous proteins with known structure. Protein threading predicts protein structures by using statistical knowledge of the relationship between the structure and the sequence.

The prediction is made by “threading” (i.e. placing, aligning) each amino acid contained in the target sequence to a position in the template structure, and evaluating how well the target fits the template. After the best-fit template is selected, the structural model of the sequence is built based on the alignment with the chosen template. The protein threading method is based on two basic observations. One is that the number of different folds in nature is fairly small (approximately 1000), and the other is that according to the statistics of the Protein Data Bank (PDB), 90% of the new structures submitted to PDB in the past three years have similar structural folds to the ones in PDB.

Homology modelling, also known as comparative modelling, of protein refers to constructing an atomic-resolution model of the “target” protein from its amino acid sequence and an experimental three-dimensional structure of a related homologous protein (the “template”). Homology modelling relies on the identification of one or more known protein structures likely to resemble the structure of the query sequence, and on the production of an alignment that maps residues in the query sequence to residues in the template sequence. The sequence alignment and template structure are then used to produce a structural model of the target. Because protein structures are more conserved than DNA sequences, detectable levels of sequence similarity usually imply significant structural similarity.

Molecular dynamics (MD) is a form of computer simulation in which atoms and molecules are allowed to interact for a period of time by approximations of known physics, giving a view of the motion of the particles. Because molecular systems generally consist of a vast number of particles, it is in general impossible to find the properties of such complex systems analytically. When the number of particles interacting is higher than two, the result is chaotic motion. MD simulation circumvents the analytical intractability by using numerical methods. It represents an interface between laboratory experiments and theory, and can be understood as a “virtual experiment”. MD probes the relationship between molecular structure, movement and function.

Molecular dynamics is a specialized discipline of molecular modelling and computer simulation based on statistical mechanics; the main justification of the MD method is that statistical ensemble averages are equal to time averages of the system, known as the ergodic hypothesis. MD has also been termed “statistical mechanics by numbers” and “Laplace's vision of Newtonian mechanics” of predicting the future by animating nature's forces and allowing insight into molecular motion on an atomic scale. However, long MD simulations are mathematically ill-conditioned, generating cumulative errors in numerical integration that can be minimized with proper selection of algorithms and parameters, but not eliminated entirely. Furthermore, current potential functions are, in many cases, not sufficiently accurate to reproduce the dynamics of molecular systems, so the much more computationally demanding Ab Initio Molecular Dynamics method must be used. Nevertheless, molecular dynamics techniques allow detailed time and space resolution into representative behaviour in phase space for carefully selected systems.

Moduli Space Applications within Molecular Modelling

The abovementioned modelling approaches may be improved by applying the ideas introduced by the present invention, because a further aspect of the invention relates to a tool for analyzing, predicting and/or quantifying secondary and/or tertiary structure and/or folding pathway of a macromolecule or a model of a macromolecule, such as a protein or protein globule. This may be provided by associating a moduli space to said molecule or model according to any of the herein listed methods and subsequently flow in the resulting moduli space.

The flow (to e.g. protein prediction) in the moduli space is preferably the gradient flow of a function. Further, said function preferably maps the moduli space of the graph onto the real numbers. The function is preferably the product of finitely many traces of parallel transports along closed edge-paths, one such factor for each element in a finite collection of closed edge-paths on the graph. The process may be eased if a plurality of sub-graph connections is combined to a first graph connection and thereafter reducing the holonomy of said first graph connection. The plurality of sub-graph connections is preferably at least partly determined from one or more data sets. The combination of sub-graph connections may be provided in a natural way, such as by means of geometrical constraints.

In one embodiment of the invention the flow in the moduli space is preferably geometrically determined, i.e. provided by geometrical constraints, such as steric constraints.

In another embodiment of the invention the flow in the moduli space is a flow towards graph connections of trivial holonomy. This flow towards trivial holonomy preferably comprises reducing the holonomy by means of gradient descent.

In yet another embodiment of the invention the flow in the moduli space is a flow towards configurations of the molecule with minimal potential energy.

In yet another embodiment of the invention flowing in the moduli space provides a set of possible configurations of the molecule.

The present invention improves the traditional molecular structure prediction methods by introducing the geometric constraints associated with the moduli space terminology. I.e. instead of applying the traditional protein threading and homology modelling the present invention introduces rotation threading, which is a statistics based empirical geometric method. And the molecular dynamics approach, where the modelling is a flow towards a minimization of the energy, is improved by the present geometric dynamics introducing the geometrically defined flow on moduli space of e.g. proteins.

In a further embodiment of the invention the energy associated to the geometric dynamics terms can be computed and manipulated efficiently using standard techniques known in the art from e.g. harmonic analysis, specifically, expressing and computing functions on SO(3) such as probability densities using the ultraspherical polynomials or other orthonormal bases for the square integrable functions defined on SO(3).

### Molecular Structural Descriptors, Families and the Like

In a further aspect of the invention, numerical and/or other descriptors of the molecule are provided from properties of the corresponding graph connection(s). The corresponding graph connection is the graph connection(s) that is the result of modelling the molecule with a graph and associating 3-frames to the bonds of the molecule.

In yet another aspect of the invention, it can be determined whether two molecules are similar based upon equality and/or similarity of the corresponding graph connections and/or descriptors.

Furthermore, a library of structures for a family of molecules is preferably provided, based upon the corresponding graph connections and/or descriptors.

In another aspect of the invention, families of molecules are provided based upon equality and/or similarity of the corresponding graph connections. Furthermore, a classification of a subject molecule within a family is preferably provided. The biological function of a molecule based upon the corresponding graph connection is also preferably provided by the method according to the invention.

In a further aspect of the invention, the melting and/or folding pathway of a molecule is modelled and/or predicted based upon the corresponding graph connection. Secondary and/or tertiary structure of a molecule may also be predicted from its primary structure. This prediction is preferably based upon libraries and/or descriptors provided from the corresponding graph connections.

In yet another aspect of the invention, the external surface and/or the active sites of a molecule is predicted from its primary structure, based upon libraries and/or descriptors provided from the corresponding graph connections.

### Computer Program Product Implementation

A further aspect the invention relates to a computer program product including a computer readable medium, said computer readable medium having a computer program stored thereon, said program for constructing and/or associating a moduli space to a molecule or a model of a molecule and comprising program code for conducting any of the steps of any of the abovementioned methods.

Further, one embodiment of the invention relates to a method executed by a computer under the control of a program, said computer including a memory for storing said program, said method comprising any of the steps of the herein mentioned methods.

Further, the invention relates to a system for constructing and/or associating a moduli space to a molecule or a model of a molecule, said system including computer readable memory having one or more computer instructions stored thereon, said instructions comprising instructions for conducting any of the steps of any of the abovementioned methods.

Even further, the invention relates to a computer program product having a computer readable medium, said computer program product providing a system for analyzing, predicting and/or quantifying secondary and/or tertiary structure and/or folding pathway of a macromolecule or a model of a macromolecule, such as a protein or protein globule, said computer program product comprising means for carrying out any of the steps of the abovementioned methods.

### Further Details Relating to Graphs and Molecules

When modelling a macromolecule by means of a graph as according to the present invention, the following steps can be provided:
read the three-dimensional structure of a macromolecule,
arrange the sequential composition of the subgraph building blocks based on the spatial coordinates of constituent atoms and type of sub-molecule and the possible additional labelling of certain edges by sub-molecules based on the primary structure,
determination of the graph itself from the additional information of bonding of sites along the backbone,
calculation of numerical and/or other descriptors from the labelled graph, and
classification, comparison, specification, analysis, and prediction of macromolecular structures derived from these descriptors.

In the case of modelling a protein or protein globule by means of a fatgraph, the following steps can be provided:
read the three-dimensional structure of a protein or protein globule and the sequence of residues along the backbone,
arrange the sequential composition of the fatgraph building blocks based on the spatial coordinates of constituent atoms and residue types and the possible additional labelling of certain edges by residues based on the primary structure,
determination of the fatgraph itself from the additional information of hydrogen bonding of sites along the backbone,
calculation of numerical or other invariants and/or descriptors from the labelled fatgraph, and
classification, comparison, specification, analysis, and prediction of protein or protein globule structures derived from these invariants and/or descriptors.

### Surfaces and Fatgraphs

A fatgraph is a graph in the usual sense of the term together with the further specification of a cyclic ordering on the half-edges about each vertex.

Example: There are 6 orderings on a set {a,b,c} with three elements:

(a,b,c),(a,c,b),(b,a,c),(b,c,a),(c,a,b),(c,b,a)

There are only two cyclic orderings on the set {a,b,c}:

(a,b,c) and (c,b,a)
since a “cyclic permutation” of (a,b,c) provides:
(a,b,c),(b,c,a),(c,a,b),
and a “cyclic permutation” of (c,b,a) provides
(c,b,a),(b,a,c),(a,c,b).

These give all the orderings, and (a,b,c) and (c,b,a) are not related by cyclic permutation. Finally, consider a graph. For each vertex, there is a finite collection of half-edges incident on it, and a ‘cyclic ordering on the half-edges about the vertex’ is just that: a cyclic ordering on the half-edges. In this example, at a 3-valent vertex of a graph, there are exactly two possible different cyclic orderings.

A surface is a two-dimensional manifold possibly with boundary. Surfaces will always have non-empty boundary and be embedded as subsets of three-dimensional space. The surface F is said to be connected if any two points of F can be joined by a continuous path in F, and Fin three-space is compact provided F contains all limit points of convergent subsequences in F, and there is some three-dimensional ball of finite radius in three-space containing F. Two surfaces are homeomorphic if there is a continuous bijection between them whose inverse is also continuous. The surface F is said to be orientable if it does not contain a subsurface which is homeomorphic to a Möbius band, and otherwise F is said to be non-orientable.

It is a classical result in mathematics that the homeomorphism type of any compact and connected surface F with boundary, is uniquely determined by the specification of whether it is orientable or non-orientable together with its genus g=g(F) and its number r=r(F) of boundary components. FIG. 6 illustrates surfaces of genus g with r boundary components with orientable surfaces indicated on the left and non-orientable surfaces on the right.

### Background on Protein Structure

Proteins are polymers of amino acids and the imino acid Proline, and each amino acid has the same basic structure, differing only in the side-chain, called the R-group. The carbon atom to which the amino or carboxyl group and side-chain are attached is called the alpha carbon atom C^{α}. Proteins are built from 19 different amino acids and the single imino acid Proline, each of which has known chemical structure and biophysical attributes including charge, three-dimensional structure, and hydrophobicity, which is a measure of the affinity of the side-chain to an aqueous environment.

A protein is a linear polymer of these amino and imino acids which are linked by peptide bonds, and the sequence of covalently bonded amino and imino acids is the primary structure of the protein given as a long word R₁, R₂, . . . , R_{L} in a 20-letter alphabet. The collective knowledge of primary structures of proteins is deposited in the databanks Swiss-Prot and Uni-Prot, which are in the public domain.

The peptide linkages, together with the alpha carbon atoms to which side-chains are attached, form the protein backbone, which is described by
N₁—C₁^{α}—C₁—N₂—C₂^{α—C}₂— . . . —Nᵢ—Cᵢ^{α}—Cᵢ— . . . —N_{L}—C_{L}^{α}—C_{L}
   where N denotes nitrogen and C or C^{α} denotes carbon. The backbone thus comes with this preferred orientation from its N to C ends.

The i′th peptide unit is comprised of the consecutively bonded atoms Cᵢ^{α}—Cᵢ—Nᵢ₊₁—Cᵢ₊₁^{α} in the backbone together with an oxygen atom Oᵢ bonded to Cᵢ and one further atom. Namely, for any amino acid residue Rᵢ₊₁, the preceding peptide unit includes a hydrogen atom Hᵢ₊₁ bonded to Nᵢ₊₁, while for the imino acid Proline Rᵢ₊₁, the preceding peptide unit includes another carbon atom in the Proline residue bonded to Nᵢ₊₁ as illustrated, respectively, on the left in FIGS. 1 and 2. Owing to quantum mechanical effects, the peptide unit is in any case essentially planar with angles of 120 degrees between adjacent bonds. This is a crucial point about the geometry of proteins. At the same time and by a similar mechanism, each Cᵢ^{α} is always covalently bonded to exactly four other atoms including Cᵢ and Nᵢ and the angles between the bonds of Cᵢ^{α} with these other atoms are essentially tetrahedral (roughly 109.5 degrees). This is another crucial point about the geometry of proteins.

The configuration of atoms and bonds in the plane of the peptide unit can thus arise in one of two basic conformations depending upon whether the bonds Cⁱ—Cᵢ^{α} and Nᵢ₊₁—Cᵢ^{α} occur on opposite sides (the trans conformation illustrated in FIG. 1) or on the same side (the cis conformation illustrated in FIG. 2) of the bond Cᵢ═Nᵢ₊₁. In fact, peptide units preceding amino acids almost always arise in the trans conformation, while peptide units preceding the imino acid Proline usually arise in the trans conformation as well but occasionally (roughly ten percent of the time) arise in the cis conformation. The explanation for these phenomena can be found in any standard textbook on proteins.

In a living cell, or more generally in an aqueous solution at room temperature, most water-soluble proteins “fold” into a stable and characteristic three-dimensional crystal, and the tertiary structure is the specification of the spatial coordinates of each constituent atom. This tertiary structure of a protein is determined by nuclear magnetic resonance or X-ray crystallography techniques, and the collective knowledge of tertiary structures is deposited in the Protein Data Bank (PDB), which is in the public domain. However, these locations of backbone atoms in the PDB should be taken with an indeterminacy of roughly 0.2 angstroms owing to experimental and modelling errors. With an even greater indeterminacy, the constituent hydrogen atoms are invisible to X-ray crystallography, and their spatial locations are inferred from an idealized geometry. Furthermore, typical covalent bond lengths along the backbone are on the order of 1.5 angstroms. The primary structure is known for many more protein molecules than is the tertiary structure.

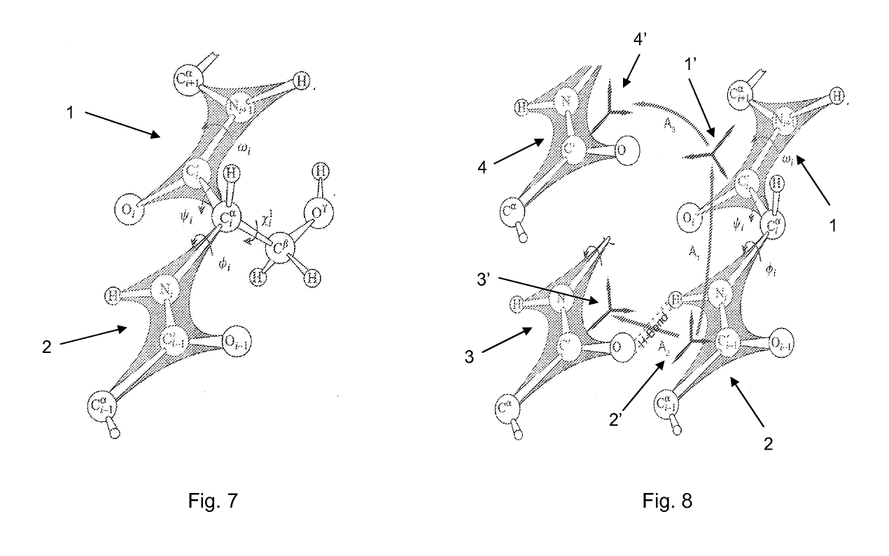

The peptide units of a folded protein are linked along the backbone as determined by the conformational angles φᵢ, ψᵢ defined to be the counter clockwise angle from the bond Cᵢ₋₁—Nᵢ to the bond Cᵢ^{α}—Cᵢ along the bond Nᵢ—Cᵢ^{α}, and ψᵢ, defined to the be counter-clockwise angle from the bond Nᵢ—Cᵢ^{α} to the bond Cᵢ—Nᵢ₊₁ along the bond Cᵢ^{α}—Cᵢ. See FIG. 3 and FIG. 7. The conformational angles φᵢ, ψᵢ thus determine the linkages between consecutive peptide units and can be unequivocally determined from the actual tertiary structure of a protein in principle, but experimental and modelling errors in the PDB render their determination with an indeterminacy of roughly 10-15 degrees.

The folded protein also determines further bonding between the constituent atoms, for example, hydrogen bonds among the various Oⱼ and Hⱼ, where i, j belong to {1, . . . , L} with |i−j|>1 in practice owing to properties of the backbone, and where two atoms are interpreted as bonded if they are within a few angstroms of one other as determined by the tertiary structure. Specifically, the electrostatic potential energies among constituent atoms of a folded protein are also determined from their spatial separations using any one of several standard methods, and a customary energy cutoff of −2.1 kJ/mole, for example, then determines bonding, i.e., any computed electrostatic bonding energy below the cutoff implies the existence of a hydrogen bond. The specification of hydrogen bonding among the atoms in the peptide units of a protein structure is called its secondary structure. Oxygen atoms may participate in more than one hydrogen bond, with two such bonds being not uncommon in practice, but hydrogen atoms almost always participate in at most one hydrogen bond.

There are several standard configurations of secondary structure in a folded protein which is defined in any textbook on proteins. The first is an α-helix, where typical consecutive conformational angles φᵢ, ψᵢ within an α-helix have small absolute differences with |φᵢ−ψᵢ| less than 45 degrees. There are furthermore parallel and anti-parallel beta strands, where typical consecutive conformational angles φᵢ, ψᵢ within a beta strand, whether parallel or anti-parallel, have large absolute differences with |φᵢ−ψᵢ| greater than 135 degrees.

There are also a number of standard configurations or motifs of α-helices and β-strands which are catalogued in the literature and are referred to as the architecture of the protein. It is important to emphasize that the determination of architecture is done “by hand” in the sense that there are no automatic methods to recognize motifs even from the full tertiary structure of a protein molecule or protein globule. The topology of the protein structure records the appearance of architecture along the backbone, and finally the homology of a protein describes its approximate primary structure.

A protein decomposes into domains or globules, which are roughly described as the smallest possible subsequences of the backbone mostly saturated for bonding. Another database in the public domain is called CATH, which catalogues the known tertiary structures of what are agreed to be protein globules, and which posits their bonding, conformational angles, architecture, topology and homology. The CATH classification is refined by CATH SOLID, where the SOLI tiers in the hierarchy reflect increasingly better agreement of primary structure as determined by sequence alignment, and the D tier is included to guarantee a unique representative in each deepest class.

At a characteristic temperature somewhat higher than room temperature, the protein molecule or globule “denatures” or melts shedding its hydrogen and other bonds but preserving the backbone. As the temperature is then decreased back to room temperature, a denatured water-soluble protein structure in an aqueous solution regains its bonds and folds back into its native state. At least this is the case for most water-soluble protein globules and molecules. This is a fundamental point: since the protein spontaneously refolds into its native state, the primary structure determines the tertiary structure, and the prediction of the latter from the former is the famous “folding problem” for proteins. A basic tenet of state-of-the-art solutions to the folding problem is that similar primary structure implies similar tertiary structure, so CATH and PDB can be used with postulated penalty functions for partial matching in order to predict new tertiary structures from known ones. The sequence of bonds and spatial coordinates of constituent atoms as the temperature decreases and the protein refolds is called the “folding pathway” of the protein structure.

The folding problem is arguably the fundamental problem of protein biophysics, namely: predict the tertiary structure of a protein molecule or protein globule from its primary structure, and an effective solution to this problem has obvious ramifications for example in de novo drug design. Databases such as PDB and CATH play crucial roles in the state-of-the-art attempts to solve this problem via the following mechanism. Given a subject protein whose tertiary structure is unknown and whose primary structure is known, one may search for subsequences of its primary structure which agree or roughly agree with subsequences of primary structure occurring for protein structures in PDB or CATH. These approximately agreeing subsequences may overlap, and a penalty function can be postulated a priori in order to determine the best-fitting collection of subsequences of approximate agreement. The presumption is that similar subsequence primary implies similar subsequence tertiary structure, so a mechanism for predicting tertiary structure is derived from the known tertiary structures via such a postulated penalty function based upon a specified database. One aspect of this method which is especially problematic is the assembly of the determined motifs of secondary structure into a full tertiary structure.

### DETAILED DESCRIPTION OF THE DRAWINGS

FIG. 1 illustrates the modelling of a peptide unit in the trans configuration with the two possible orientations (positive and negative) of the peptide planes. The middle horizontal line segment represents the carbon nitrogen bond. A vertical line segment is attached on each side of the horizontal line segment, the first and leftmost vertical line segment (half-edge) represents an oxygen site and the second and rightmost vertical line segment represents a hydrogen site. As seen from the figure, the relative position of the first and leftmost vertical line segment (i.e. the oxygen site) corresponds to the location of the oxygen atom on the backbone of the peptide unit when traversed in its natural orientation from the nitrogen end to the carbon end. The second and rightmost vertical line segment (i.e. the hydrogen site) is located on the opposite side of the horizontal line segment.

FIG. 1 also associates two subgraph building blocks when modelling a protein by means of a graph. The endpoints of the horizontal segment are labelled by the corresponding residues denoted by Rᵢ, Rᵢ₊₁ in FIG. 1. The endpoints of the vertical segments not lying in the horizontal segment correspond to the oxygen and hydrogen atoms of the peptide unit and are referred to as the Oᵢ and Hᵢ₊₁ sites as illustrated. Depending upon the orientation of the plane of the peptide unit, exactly one of two possibilities holds: the oxygen atom lies either to the right or the left of the backbone when traversed in its natural orientation from its nitrogen to carbon ends. These two possibilities correspond to the two possible subgraph building blocks for each peptide unit. If the residue the imino acid Proline, then the endpoint of the rightmost vertical segment represents a carbon atom in the Proline residue, which is therefore not involved in hydrogen bonding. This is indicated in FIG. 1 for trans-Proline.

FIG. 2 illustrates the modelling of a peptide unit preceding a cis-Proline, or the very rare case of a cis conformation preceding another amino acid, with the two possible orientations (positive and negative) of the peptide planes. Just as for the trans conformation illustrated in FIG. 1, exactly one of two possibilities holds: the oxygen atom lies either to the right or the left of the backbone when traversed in its natural orientation from its nitrogen to carbon ends. The second and rightmost vertical line segment represents a carbon site. The dotted line in the figure more accurately reflects the location of the corresponding bond between Nᵢ₊₁ and the carbon atom in the Proline residue, which is again necessarily never involved in hydrogen bonding.

FIG. 2 also associates two subgraph building blocks when modelling a protein by means of a graph, in this case the two possible subgraph building blocks represent peptide units preceding a cis-Proline or another amino.

FIG. 3 illustrates how subgraph building blocks can be connected along the backbone when modelling a protein or protein globule by means of a fatgraph. The model of the protein backbone is determined by the sequence of configurations, positive or negative, assigned to the consecutive peptide units and is thus described by a word of length L−1 in the alphabet {±}={+,−}. The untwisted fatgraph modelling the protein backbone is constructed from this data by identifying endpoints of the consecutive horizontal segments of the fatgraph building blocks in the natural way without introducing vertices between them so as to produce a long horizontal segment comprised of 2L−1 horizontal segments with 2L−2 short vertical segments attached to it. There is an arbitrary choice of configuration c₁=+ for the first building block as positive.

FIG. 4 illustrates the two standard conformational angles φᵢ and ψᵢ along the peptide bonds of the backbone incident on the alpha carbon atom Cᵢ^{α}, of the i′th amino acid residue. Two peptide units, as depicted in FIGS. 1 and 2, are incident on this alpha carbon atom, and to each one is associated a subgraph building block. These building blocks are taken to agree if the absolute difference |φᵢ−ψᵢ| is “small”, and they are taken to disagree if this absolute difference is “large”, where these notions of “small” and “large” are discussed below. Only one of the two possible configurations for the i′th building block in its trans conformation is depicted in FIG. 4.

FIG. 5 illustrates modelling of hydrogen bonds, i.e. edges are added to the concatenation of subgraph building blocks representing a backbone. If the oxygen atom Oᵢ of the i′th peptide unit is hydrogen bonded to the hydrogen atom Hⱼ of the j′th peptide unit, then an edge is added connecting the oxygen site of the i′th building block with the hydrogen site of the j′th building block. Adding one such edge for each hydrogen bond along the backbone completes the determination of the graph associated to a protein molecule or protein globule. The various cases depending upon the subgraph building blocks associated to the i′th and j′th peptide units as well as the two cases depending upon i<j or i>j are all depicted.

The untwisted fatgraph T of the backbone model may be regarded as a long horizontal line segment composed of 2L−1 short horizontal segments with 2L−2 short vertical segments attached to it. The short vertical line segments represent the atoms Oᵢ, Hᵢ of the peptide units, where Hᵢ is absent (and corresponds to a carbon atom) if residue Rᵢ is Proline, for i=1, . . . , L.

If (i, j) belongs to the collection B of pairs (i, j), then an edge is added to the long horizontal segment connecting the short vertical segments corresponding to the atoms Hᵢ and Oⱼ. The various cases are depicted in FIG. 5.

Applying this to the backbone model T using the hydrogen bonds specified in B, an untwisted fatgraph is provided. This fatgraph is denoted T′. It is important to emphasize that the relative positions of these added edges corresponding to hydrogen bonds other than their endpoints, is completely immaterial to the strong equivalence class of the fatgraph constructed, so this truly produces a well-defined strong equivalence class of untwisted fatgraphs uniquely determined from the input data.

To complete the construction, it remains only to determine which edges of the fatgraph T′ are twisted. To this end, suppose that (i,j)εB reflecting that there is a hydrogen bond connecting Hᵢ and Oⱼ. According to the enumeration of peptide units, Hᵢ occurs in peptide unit i−1 and Oⱼ occurs in peptide unitⱼ. As previously written, there are corresponding 3-frames

(\vec{u}ᵢ₋₁,\vec{v}ᵢ₋₁,\vec{w}ᵢ₋₁)=ℑᵢ₋₁

(\vec{u}ᵢ₋₁,\vec{v}ᵢ₋₁,\vec{w}ᵢ₋₁)=ℑⱼ

and corresponding configurations cᵢ₋₁ and cⱼ.

An edge corresponding to the hydrogen bond (i,j)εB is taken to be twisted if and only if cᵢ₋₁cⱼ sign(\vec{v}ᵢ₋₁·\vec{v}ⱼ+\vec{w}ᵢ₋₁·\vec{w}ⱼ) is negative.

Applying this to the untwisted fatgraph T′ completes the definition of the fatgraph denoted G₁=G₁(Eₘᵢₙ, Eₘₐₓ), the fatgraph model of the protein structure determined by the inputs based on the bifurcation parameter β=1 and energy thresholds Eₘᵢₙ<Eₘₐₓ<0. In this notation, β is a parameter of the model that determines the maximum number of hydrogen bonds in which an oxygen or hydrogen atom may participate, and the energy thresholds are likewise parameters of the model which determine a hydrogen bond with energy E provided Eₘᵢₙ<E<Eₘₐₓ with the standard default values Eₘₐₓ=−0.5 kcal/mole and Eₘᵢₙ given by minus infinity.

There are several points to make about this determination. Though it is not clear from this formulation, hydrogen bonds are thereby treated in the same manner as the linkages between peptide units, and this is natural from the point of view of SO(3) graph connections. Furthermore, under errors of determinations of which edges are twisted and errors in the plus/minus sequence, the number of boundary components of F(G) will change by at most the total number of errors. This is a crucial point.

The fatgraph G can be further labelled using the primary structure in the natural way, where the label Rᵢ of the i′th residue is associated to the sub-segment of the long horizontal segment along the backbone immediately preceding the short vertical segment representing Oᵢ for i=1, . . . , L.

FIG. 7 illustrates atomic locations and conformational angles φᵢ, ψᵢ and χᵢ determining the orientation of two bonded peptide units 1, 2 of e.g. a protein. These conformational angles were an important part of the previous fatgraph application WO 2010/000268.

FIG. 8 illustrates the generalization provided by the present invention. The SO(3) element A₁ replaces the conformational angles because A₁ describes the rotation of the 3-frame 2′ associated with the lower peptide unit 2 into the 3-frame 1′ associated with the upper peptide unit 1. A third peptide unit 3 is hydrogen bonded (secondary protein structure) to peptide unit 2 and the SO(3) element A₂ describes the rotation of the 3-frame 2′ into the 3-frame 3′. A fourth peptide unit 4 is adjacent to peptide unit 1 (tertirary structure) and the SO(3) element A₃ represents the rotation of the associated 3-frames 1′ and 4′. All in all the triple A₁, A₂, A₃ provides a point in the moduli space of proteins.

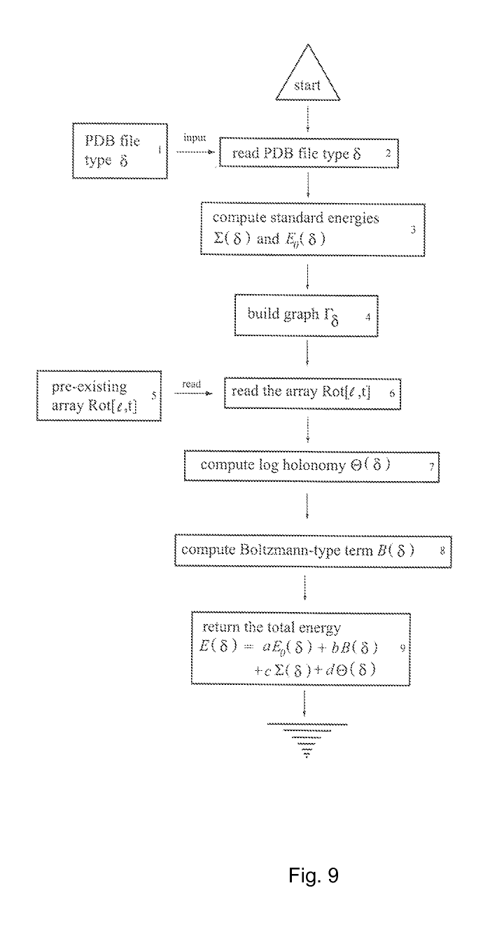

FIG. 9 is a flowchart illustrating the calculation of the total energy E(δ) used in molecular dynamics including standard and novel geometric terms. This flowchart will now be described in more detail with reference to the numbered program segment boxes.

Program Segment 1 contains a data file δ in the PDB format, namely, the file δ contains the primary and tertiary structures of a polypeptide in the standardized format of the Protein Data Bank. Such a data file is input in Program Segment 2. It is important to emphasize that (5 is not necessarily a file from the PDB itself but rather might more typically be the corresponding data associated with a polypeptide configured in some transitional state along its in silico folding pathway, for example, in applications to molecular dynamics.

Program Segment 3 computes the standard energy ΣZ(δ) corresponding to the steric constraints and the sum total E₀(δ) of the other energetics, e.g., electrostatic, hydrophobic, etc., of some particular model of molecular energetics of a protein. For example, two standard methods known in the art in the public domain for computing the total energy E₀(δ)+Σ(δ) are

ProFASi: http://cbbp.thepiu.se/activities/profasilindex.html, and
TINKER: http://dasherwustLedultinker/.

Program Segment 4 constructs the graph [symbol] ₅ corresponding to the data δ as follows: Various types of incidences of peptide units are defined a priori. For example and by convention, two peptide units that are consecutive along the backbone share an incidence of type one. For further examples, two peptide units might share an incidence of type two if it is determined that there is a hydrogen bond (as specified by the DSSP conventions for example) between their constituent atoms in the peptide units; an incidence of type three corresponds to peptide units whose residues are determined to be in spatial contact (using, for example, the conventions of SCRWL4 (http://dunbrack.femedu/scwrl4/SCWRL4.php) or using ball-and-stick or other models such as that described in “Computer simulation of protein folding” (M. Levitt and A. Warshel, Nature 253 (1975), 694-698); any of a number of further extensions or specifications of these types, for example, stipulating the amino acid types, secondary structures, discretized hydrophobicities, charges or other physico-chemical attributes of specified residues.

At any rate, for each occurrence of each type of incidence, there is an edge e of the associated graph [symbol] _{δ} constructed in this program segment. In particular and by definition, each incidence of type one corresponds to an alpha carbon linkage between the two basic fatgraph building blocks associated to peptide units that are consecutive along the backbone. Edges are added to this basic model of the backbone in the natural way, one edge for each incidence regardless of type to complete the definition of the graph [symbol] _{δ}.

Notice that for each non-backbone edge e of [symbol] _{δ}, i.e., for each edge of [symbol] _{δ} whose type differs from one, there is a unique simple cycle γₑ in [symbol] _{δ} passing only through e and certain edges in the backbone. Cycles and edges of [symbol] _{δ} can be oriented using the natural orientation of the polypeptide backbone by making choices, so we shall simply regard each edge or cycle of [symbol] _{δ} as being oriented. Thus, for each edge e of [symbol] _{δ}, there is an associated element of SO(3), namely, the unique rotation carrying the orthonormal 3-frame corresponding to the peptide unit containing the initial point of e to the 3-frame corresponding to the terminal point of e. This gives an SO(3)-graph connection ζ_{δ} on [symbol] _{δ}.

In particular restricting to the edges of type one gives the backbone graph connection, which has trivial holonomy for the simple reason that the backbone is contractible. Furthermore, to each edge e of type greater than one, the holonomy

hζ_{δ}(γₑ)=⅓trace(ζ_{δ}(γₑ))

of ζ_{δ} along e satisfies hζ_{δ}(γₑ)=1 since ζ_{δ} arises from a collection of 3-frames in space. In this formula if the simple cycle γ serially traverses oriented edges e₁, e₂, . . . , eₙ, where the terminal point of eₙ agrees with the initial point of e₁, then the holonomy in SO(3) of the graph connection ζ_{δ} along γ is defined to be

ζ(γ)=ζ(eₙ) . . . ζ(e₂)ζ(e₁)εSO(3).

Program Segment 5 contains empirical data which is read in Program Segment 6. The stored data consists of an array Roth[l, t] of subsets of SO(3) determined as follows: The argument t≧1 ranges over the types of incidences of peptide units, and the argument l ranges over 4-tuples of amino acids adjacent to the two peptide units involved in the incidence. The family Rot[l₀, t₀]⊂SO(3) is the collection of all the rotation matrices for the type t₀ incidence arising with the primary structure label l₀ over some specified subset of PDB, for instance, the entire database, a trusted or specialized subset. In effect, this choice of subset corresponds to a training set for later prediction which may or may not contain δ.

For each entry of Rot a mean A[l₀, t₀]⊂SO(3) and non-negative dispersion d[l₀, t₀] of the corresponding subset Rot[l₀, t₀] c SO(3) may be computed. Indeed, these empirical data can be pre-computed and simply read in this procedure. In a preferred embodiment, the mean of a subset of SO(3) is taken to be its Fréchet mean, cf. Bi-invariant means in Lie groups by V. Arsigny, X. Pennec, N. Ayache (INRIA No. 5885 (2006), ISSN 0249-6399), and the dispersion to be its metric diameter; other reasonable notions of mean and dispersion also exist in the prior art in the public domain, cf. “A statistical model for random rotations” by C. Leon, J.-C. Mass_e, L.-P. Rivest (Journal of Multivariate Analysis 97 (2006), 412-430). As a convention, if Rot[l₀, t₀] is too small or otherwise unreliable as a predictive tool, then the dispersion d[l₀, t₀] can be set to infinity.

Define another SO(3) graph connection η_{δ} on [symbol] _{δ} as follows: Suppose the edge e of [symbol] _{δ} is of type t₀ with primary structure label l₀, and let η_{δ}(e)=A[l₀, t₀] provided the dispersion d[l₀, t₀] is sufficiently small. In the contrary case that the dispersion is too large, then η_{δ}(e) may be set to some nominal value; in a preferred embodiment when the type is greater than one, η_{δ}(e) is the unique rotation that extends the backbone graph connection with trivial holonomy, while if the type is one, then η_{δ}(e) is nominally set to the identity. The total holonomy is given by non-backbone

$$H ( δ ) = {\prod }_{non - backbone e} {h}_{{η}_{δ}} ( {γ}_{e} )$$

and the log holonomy term computed in Program Segment 7 is

$$Θ ( δ ) = log \vert H ( δ ) \vert = {\prod }_{non - backbone e} log \vert {h}_{{η}_{δ}} ( {γ}_{e} ) \vert$$

Armed with this array Roth[l, t], the probability 0≦π_{δ}(e)≦1 of the rotation associated with the edge e of [symbol] _{δ} conditioned on the data in Roth[l, t] may also be computed. In a preferred embodiment with a particular statistical model, Rot[l₀, t₀]⊂SO(3) is represented as a sum of smeared Dirac delta functions, one centred at each point in the subset, where the bi-invariant metric on SO(3) is conveniently used to smear and replace the delta function at a point by the characteristic function of a small metric ball centred at that point. The total Boltzmann-like contribution to the energy based on geometry provided by Program Segment 8 is given by

B(δ)=−Σ log π_{δ}(e),

where the sum is over some subset of edges of [symbol] _{δ}; for example, the subset could be the entire set of edges of [symbol] _{δ}, or the different types of incidences could give rise to separate Boltzmann-like terms combined into the total with parameters that can be optimized over some specified database.

Finally, Program Segment 9 returns the total energy

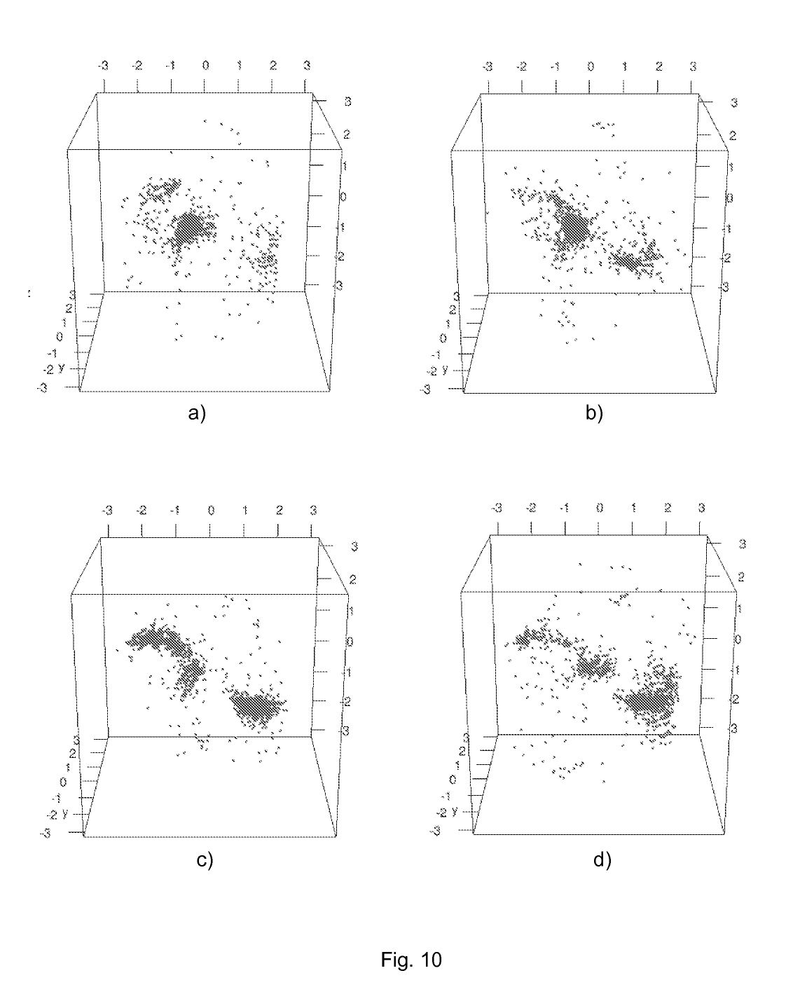

E(δ)=aE₀(δ)+bB(δ)+cΣ(δ)+dΘ(δ),

where the parameters a, b, c, d≧0 are tuned by optimization over some training set and/or artificially specialized to enforce some choice of model. For example: the model of prior art is simply b=d=0 where a=c=1 has already been achieved via parametric optimization; a purely geometric model has a=b=0; and a=b=c=0 is a standard method known in the art of moduli spaces in mathematics, where one flows along the gradient of Θ from an arbitrary graph connection to one with trivial log holonomy Θ≡0. Even this last very special case of a purely holonomic model is a novel technique in bio-informatics for meaningfully combining a collection of graph connections, which may reflect contradictory predictions arising from different data or different aspects of a protein or polypeptide.
FIGS. 10a-10d

Another application of the present invention on existing protein data from the CATH database is illustrated in FIGS. 10a-10d which show scatter plots for hydrogen bonding over the entire CATH database involving the amino acids. FIG. 10a shows “*AAL”, FIG. 10b shows “AA*A”, FIG. 10c shows “DL*D” and FIG. 10d shows “V*GV” where A=Alanine, D=Aspartic acid, G=Glycine, L=Leucine, V=Valine, *=wildcard.

The statistics of hydrogen bonding over the entire CATH database has been computed in the following form: Consider an eight tuple WXYZpqrs, where each of W,X,Y,Z is one of the 20 amino acids and each of p,q,r,s is one of the 8 types of secondary structure used in DSSP (Define Secondary Structure of Proteins—the DSSP algorithm is the standard method for assigning secondary structure to the amino acids of a protein, given the atomic-resolution coordinates of the protein). Suppose there are two peptide units P and Q sharing a hydrogen bond from P to Q, where peptide unit P has primary structures W,X and secondary structures p,q along the backbone from the N- to C-terminus, and likewise peptide unit Q has primary structures Y,Z and secondary structures r,s. In this case, deposit in a data file labelled WXYZpqrs the element of SO(3) mapping the 3-frame of P to that of Q. In principal, a library with 160⁴=655,360,000 files is then produced, but many of these are empty. In fact even for the non-empty ones, there is typically insufficient data in CATH to be statistically meaningful on so refined a level, so various collections of files from this library are merged in order to achieve meaningful results. In FIGS. 10a-10d several examples of the distribution of points on SO(3) for various triples of amino acids with scatter plots are illustrated.

In the scatter plots in FIGS. 10a-10d, a point of SO(3) can be described in its angle-axis form as rotation by an angle a about an unit vector (u,v,w), and the point a(u,v,w) may be conveniently plotted in 3-space, where x is horizontal, y goes into the page, and z is vertical in the figure; this representation is a good one provided the absolute value of a is somewhat less than pi. For example FIG. 10a (showing “*AAL”) illustrates the distribution of elements of SO(3) occurring when there is a hydrogen bond from a peptide unit with primary label*A, where * denotes a wildcard, to a peptide unit with primary label AL, i.e., the figure represents the union of all the files with primary descriptor *AAL in the computed library, where * varies over all 20 amino acids for any possible secondary structures. Equivalent with FIGS. 10b, 10c and 10d.

FIGS. 10a-10d are therefore the 3D analogues for hydrogen bonds of the usual 2D Ramachandran plots of conformational angles along the backbone. It is clearly seen that there is clustering of the achieved rotations in each of the FIGS. 10a-10d, and this is to be expected since a pair of peptide units with fixed primary structure should be able to come into spatial proximity in only several essential ways because of steric constraints. Furthermore, from FIGS. 10a-10d it can be seen that varying the primary structure in the various examples leads to different clustering, and this is obviously a useful attribute when trying to predict tertiary from primary structure, i.e. the present invention is of evident relevance and value for the protein folding problem.

Analogous libraries for pairs of peptide units that are in close spatial proximity but do not share hydrogen bonds have also been computed, and all these same comments apply mutatis mutandis in this other context. Still other libraries can also be produced, for example for disulfide bridges.

### Example of a Protein Specific Embodiment of the Invention

The following relates to a protein specific embodiment of the invention. The first step is to model a protein or protein globule by means of a graph. This procedure is described elsewhere in this application. As input to the method may be provided the specification for a folded protein, protein globule, or any consecutive sequences along the backbone which is saturated for hydrogen bonding of:
i) the primary structure given as a sequence Rᵢ of letters in the 20-letter alphabet of amino and imino acid residues, for i=1, . . . , L,
ii) the displacement vector \vec{x}ᵢ from Cᵢ to Nᵢ₊₁ and the displacement vector \vec{y}ᵢ from Cᵢ^{α} i to Cᵢ in each peptide unit, for i=1, . . . , L−1,
iii) the determination of hydrogen bonding among {Hᵢ, Oᵢ, i=1, . . . , L} described as a collection B of pairs (hⱼ, oⱼ) indicating that Hₕ_{_{—}}ⱼ is bonded to Oₒ_{_{—}}ⱼ, where hⱼ, oⱼ belong to {1, . . . , L} and j=1, . . . , B.

These data are either immediately given in or may be readily derived from databanks such as Swiss-Prot, PDB, and CATH.

Preferably a 3-frame is associated to each peptide unit along the backbone of the molecule. A 3-frame Fᵢ=(\vec{u}ᵢ,\vec{v}ᵢ,\vec{w}ᵢ) associated to a peptide unit R, preferably comprises the unit vectors \vec{u}ᵢ, \vec{v}ᵢ and \vec{w}ᵢ where \vec{u}ᵢ is the unit displacement vector from the alpha carbon atom Cᵢ^{α} of said peptide unit Rᵢ towards the nitrogen atom Nᵢ₊₁ of the consecutive peptide unit Rᵢ₊₁, \vec{u}ᵢ is the unit vector provided from projecting a vector from the alpha carbon atom Cᵢ^{α} of said peptide unit Rᵢ towards the other carbon atom Cᵢ of said peptide unit Rᵢ onto the perpendicular direction of vector \vec{u} in the plane of the peptide unit Rᵢ and \vec{w} is the cross product of \vec{u} and \vec{w} in this order.

In other words: A 3-frame Fᵢ=(\vec{u}ᵢ, \vec{v}ᵢ, \vec{w}ᵢ) associated to a peptide unit Rᵢ comprises the unit vectors \vec{u}ᵢ, \vec{v}ᵢ and \vec{w}ᵢ defined as:

$${\vec{u}}_{i} = \frac{1}{\vert {\vec{x}}_{i} \vert} {\vec{x}}_{i} , \\ {\vec{v}}_{i} = \frac{1}{\vert {\vec{y}}_{i} - ( {\vec{u}}_{i} \cdot {\vec{y}}_{i} ) {\vec{u}}_{i} \vert} ( {\vec{y}}_{i} - ( {\vec{u}}_{i} \cdot {\vec{y}}_{i} ) {\vec{u}}_{i} ) , \\ {\vec{w}}_{i} = {\vec{u}}_{i} \times {\vec{v}}_{i}$$

where \vec{x}ᵢ is vector from the alpha carbon atom Cᵢ^{α} of said peptide unit Rᵢ to the nitrogen atom Nᵢ₊₁ of the consecutive peptide unit Rᵢ₊₁, \vec{y}ᵢ is the vector from the alpha carbon atom Cᵢ^{α} to the other carbon atom Cᵢ of said peptide unit Rᵢ.

Furthermore, an element of SO(3) may be associated to pairs of 3-frames of consecutive peptide units. The primary structure of the protein is thereby described by means of elements of SO(3). The secondary structure can also be described by SO(3) elements by associating pairs of 3-frames to hydrogen bonded peptide units. Correspondingly the tertiary structure of the protein may be coupled to SO(3) elements by associating pairs of 3-frames of adjacent and/or closely lying peptide units. The definition of “closely lying” may be defined e.g. by means of a maximum distance between peptide units. Adjacent peptide units may be directly inferred if the tertiary structure of the protein is known.

1.-110. (canceled)

111. A method for constructing and associating a moduli space to a molecule or a model of a molecule, said method comprising the steps of:
a) associating a graph to said molecule, said graph comprising vertices and edges, wherein vertices are associated with atoms (points) and edges are associated with chemical bonds between atoms,
b) associating a 3-frame to each of at least two bonds in the molecule,
c) providing at least one graph connection of said graph by associating an element of a Lie group to at least one pair of said 3-frames, and
d) providing a moduli space of the molecule as the moduli space of general graph connections of said graph for said Lie group.

112. The method according to claim 111, wherein each 3-frame is a positively oriented orthonormal 3-frame.

113. The method according to claim 111, wherein a 3-frame is associated to each chemical bond in the molecule.

114. The method according to claim 111, wherein an element of the Lie group is associated to each adjacent pair of 3-frames.

115. The method according to claim 111, wherein the Lie group is a rotation group.

116. The method according to claim 111, wherein the Lie group is the special orthogonal group SO(3), whereby the moduli space is an SO(3) moduli space of general graph connections of said graph.

117. The method according to claim 111, wherein a 3-frame F=(\vec{u},\vec{v},\vec{w})) associated to a chemical bond comprises the unit vectors \vec{u}, \vec{v} and \vec{w} where \vec{u} is the unit vector in the direction of the chemical bond, \vec{v} is the unit vector provided from projecting a vector from the initial point of the chemical bond towards the heaviest sub-molecule onto the perpendicular direction of vector \vec{u}, and \vec{w} is the cross product of \vec{u} and \vec{w} in this order.

118. The method according to claim 111, wherein a 3-frame Fᵢ=(\vec{u}ᵢ, \vec{v}ᵢ, \vec{w}ᵢ) associated to a chemical bond comprises the unit vectors \vec{u}ᵢ, \vec{v}ᵢ and \vec{w}ᵢ defined as:
$${\vec{u}}_{i} = \frac{1}{\vert {\vec{x}}_{i} \vert} {\vec{x}}_{i} , \\ {\vec{v}}_{i} = \frac{1}{\vert {\vec{y}}_{i} - ( {\vec{u}}_{i} \cdot {\vec{y}}_{i} ) {\vec{u}}_{i} \vert} ( {\vec{y}}_{i} - ( {\vec{u}}_{i} \cdot {\vec{y}}_{i} ) {\vec{u}}_{i} ) , \\ {\vec{w}}_{i} = {\vec{u}}_{i} \times {\vec{v}}_{i}$$
where \vec{x}ᵢ is the vector from a first atom of the chemical bond to a second atom of the chemical bond and \vec{y}ᵢ is the vector from said first atom to the heaviest sub-molecule.

119. The method according to claim 111, wherein the molecule can be represented by a concatenation of at least two sub-molecules.

120. The method according to claim 111, wherein the graph comprises a sequence of subgraph building blocks, each subgraph building block preferably representing a sub-molecule.

121. The method according to claim 120, wherein each subgraph building block comprises a horizontal line segment and a vertical line segment attached on each side of the horizontal line segment, each horizontal and vertical line segment corresponding to an edge of the graph and representing a chemical bond between constituent atoms of the molecule.

122. The method according to claim 111, further comprising the step of obtaining the spatial coordinates and the relative spatial location of the constituent atoms of the molecule.

123. The method according to claim 120, further comprising the steps of:
correlating the position of the first subgraph building block with the spatial coordinates of constituent atoms of the first sub-molecule,
connecting the subgraph building blocks in series based upon the relative spatial coordinates of constituent atoms comprising the sub-molecules, and
provide edges to the graph by connecting segments of the subgraph building blocks, each such edge corresponding to a chemical bond of the molecule.

124. The method according to claim 120, wherein each subgraph building block comprises a horizontal line segment, said horizontal line segment preferably representing a carbon nitrogen bond, and a vertical line segment attached on each side of the horizontal line segment, the first and leftmost vertical line segment representing an oxygen site, said method furthermore comprising the steps of:
correlating the position of the first and leftmost vertical line segment of each subgraph building block with the orientation of the oxygen atom on the backbone of the sub-molecule,
connecting the horizontal segments of the subgraph building blocks in series based upon the relative spatial coordinates of constituent atoms comprising the sub-molecules, and
providing edges to the graph by connecting vertical segments, each edge corresponding to a hydrogen bond along the backbone of the molecule.

125. The method according to claim 111, wherein the molecule is a macromolecule such as a biomolecule.

126. The method according to claim 125, wherein the graph is determined by the primary structure of the macromolecule.

127. The method according to claim 111, wherein the graph is constructed at least partly based on data from the protein data bank (PDB).

128. The method according to claim 111, wherein the molecule is a binary macromolecule or a non-binary macromolecule.

129. The method according to claim 111, wherein the molecule is one or more of the following types: protein, protein globule, enzyme, ligand, linear polymer, nucleotide, nucleic acid, mRNA, rRNA, tRNA, DNA, fragment of DNA.

130. The method according to claim 111, wherein a 3-frame is associated to each peptide unit along the backbone of the molecule.

131. The method according to claim 111, wherein a 3-frame Fᵢ=(\vec{u}ᵢ, \vec{v}ᵢ, \vec{w}ᵢ) associated to a peptide unit Ri comprises the unit vectors \vec{u}ᵢ, \vec{u}ᵢ and \vec{w}ᵢ where \vec{u}ᵢ is the unit displacement vector from the alpha carbon atom Ciα of said peptide unit Ri towards the nitrogen atom Ni+1 of the consecutive peptide unit Ri+1, \vec{v}ᵢ is the unit vector provided from projecting a vector from the alpha carbon atom Ciα of said peptide unit Ri towards the other carbon atom Ci of said peptide unit Ri onto the perpendicular direction of vector \vec{u} in the plane of the peptide unit Ri, and \vec{w} is the cross product of \vec{u} and \vec{w} in this order.

132. The method according to claim 111, wherein a 3-frame Fᵢ=(\vec{u}ᵢ, \vec{v}ᵢ, \vec{w}ᵢ) associated to a peptide unit Ri comprises the unit vectors \vec{u}ᵢ, \vec{v}ᵢ and \vec{w}ᵢ defined as:
$${\vec{u}}_{i} = \frac{1}{\vert {\vec{x}}_{i} \vert} {\vec{x}}_{i} , \\ {\vec{v}}_{i} = \frac{1}{\vert {\vec{y}}_{i} - ( {\vec{u}}_{i} \cdot {\vec{y}}_{i} ) {\vec{u}}_{i} \vert} ( {\vec{y}}_{i} - ( {\vec{u}}_{i} \cdot {\vec{y}}_{i} ) {\vec{u}}_{i} ) , \\ {\vec{w}}_{i} = {\vec{u}}_{i} \times {\vec{v}}_{i}$$
where \vec{x} is vector from the alpha carbon atom Cᵢ^{α} of said peptide unit Rᵢ to the nitrogen atom N_{I+1} of the consecutive peptide unit Rᵢ₊₁, \vec{y}ᵢ is the vector from the alpha carbon atom Cᵢ^{α} to the other carbon atom Cᵢ of said peptide unit Rᵢ.

133. The method according to claim 116, wherein an element of SO(3) is associated to pairs of 3-frames of consecutive peptide units.

134. The method according to claim 116, wherein an element of SO(3) is associated to pairs of 3-frames of hydrogen bonded peptide units (secondary structure).

135. The method according to claim 116, wherein an element of SO(3) is associated to pairs of 3-frames of adjacent l closely lying peptide units (tertiary structure).

136. The method according to claim 135, wherein the molecule is a protein or protein globule and wherein adjacent peptide units are determined by and/or inferred from the tertiary structure of the protein.

137. The method according to claim 116, wherein an element of SO(3) is associated to any possible pair of 3-frames.

138. The method according to claim 111, further comprising the step of calculating the parallel transport operator of at least one oriented edge-path in the graph.

139. The method according to claim 138, wherein an oriented edge-path in the graph is described by consecutive oriented edges e0-e1- . . . -ek+1, where the terminal point of ei is the initial point of ei+1, for i=0, . . . , k and the parallel transport operator of the SO(3) graph connection along γ is given by the matrix product ρ(γ)=Ae_{—}0Ae_{—}1 . . . Ae_kεE SO(3).

140. The method according to claim 111, further comprising the step of searching for trivial and/or non-trivial holonomy for a plurality of graph connections in the moduli space of the graph.

141. The method according to claim 111, wherein the holonomy of a graph connection along an oriented edge-path γ is defined as trace(ρ(γ)) where trace(ρ(γ)) is the parallel transport operator of the SO(3) graph connection along γ.

142. The method according to claim 111, further comprising the step of excluding configurations of graph connections from the moduli space that violate steric constraints.

143. The method according to claim 111, further comprising the step of excluding configurations of graph connections that provide non-trivial holonomy.

144. A method for analyzing, predicting and/or quantifying secondary and/or tertiary structure and/or folding pathway of a macromolecule or a model of a macromolecule, such as a protein or protein globule, said method comprising the steps of:
a) constructing and associating a moduli space to said molecule or model according to the method of claim 111, and
b) flowing in the moduli space.

145. The method according to claim 144, wherein the flow in the moduli space is the gradient flow of a function.

146. The method according to claim 145, wherein said function maps the moduli space of the graph onto the real numbers.

147. The method according to claim 145, further comprising the step of combining a plurality of sub-graph connections to a first graph connection and subsequently reducing the holonomy of said first graph connection.

148. The method according to claim 147, wherein the plurality of sub-graph connections is at least partly determined from one or more data sets.

149. The method according to claim 147, wherein the combination of sub-graph connections is provided in a natural way, such as by means of geometrical constraints.

150. The method according to claim 145, wherein said function is the product of finitely many traces of parallel transports along closed edge-paths, one such factor for each element in a finite collection of closed edge-paths on the graph.

151. The method according to claim 144, wherein the flow in the moduli space is at least partly determined by geometrical constraints, such as steric constraints.

152. The method according to claim 144, wherein the flow in the moduli space is a flow towards graph connections of trivial holonomy.

153. The method according to claim 152, wherein the flow towards trivial holonomy comprises reducing the holonomy by means of gradient descent.

154. The method according to claim 144, wherein the flow in the moduli space is a flow towards configurations of the molecule with minimal potential energy.

155. The method according to claim 144, wherein the step of flowing in the moduli space provides a set of possible configurations of the molecule.

156. A computer program product including a computer readable medium, said computer readable medium having a computer program stored thereon, said program suitable for constructing and/or associating a moduli space to a molecule or a model of a molecule and comprising program code for conducting all the steps of the method according to claim 111.
